(19) United States
(12) Patent Application Publication
(10) Pub. No.: US 2026/0082453 A1
(43) Pub. Date: Mar. 19, 2026

(54) MULTI-LAYER SUSCEPTOR ARRANGEMENT FOR INDUCTIVELY HEATING AN AEROSOL-FORMING SUBSTRATE

(71) Applicant: Philip Morris Products S.A., Neuchatel (CH)

(72) Inventor: Andreas Michael ROSSOLL, Le Mont-sur-Lausanne (CH)

(73) Assignee: Philip Morris Products S.A., Neuchatel (CH)

(21) Appl. No.: 19/110,534

(22) PCT Filed: Sep. 27, 2023
(86) PCT No.: PCT/EP2023/076676

§ 371 Date: Mar. 11, 2025

(30) Foreign Application Priority Data
Sep. 28, 2022 (EP) 22198256.4

(51) Int. Cl. H05B 6/10; A24D 1/20; A24F 40/20; A24F 40/465; C22C 19/05

(52) U.S. Cl. CPC H05B 6/10; A24D 1/20; A24F 40/20; A24F 40/465; C22C 19/05

(57) ABSTRACT

A multi-layer susceptor arrangement for inductively heating an aerosol-forming substrate is provided, the multi-layer susceptor arrangement including: a first layer including a first susceptor material; a second layer including a second susceptor material; and a third layer including a third material, the second layer being sandwiched between the first layer and the third layer, the second susceptor material including a Ni-Fe-alloy having a Ni content of equal to or smaller than 65 wt %, and a layer thickness of the third layer being equal to or smaller than 20% of a layer thickness of the first layer.

The present invention relates to a multi-layer susceptor arrangement for inductively heating an aerosol-forming substrate as well as to an inductively heatable aerosol-generating article comprising an aerosol-forming substrate and such a multi-layer susceptor arrangement for heating the substrate The invention further relates to an aerosol-generating article and an aerosol-generating system comprising an aerosol-generating article and an inductively heating aerosol-generating device for use with the article.

Generating aerosols by inductively heating aerosol-forming substrates which are capable to form an inhalable aerosol upon heating is generally known from prior art. For heating the substrate, the substrate may be part of an aerosol-generating article that is received within an aerosol-generating device. The device may comprise an induction source for generating an alternating magnetic field used to inductively heat a susceptor arrangement by inducing at least one of eddy currents and hysteresis losses in the material of the susceptor arrangement. The susceptor arrangement may be integral part of the article and arranged such as to be in thermal proximity or direct physical contact with the substrate to be heated. Alternatively, the susceptor arrangement may be part of the device and get into thermal proximity or direct physical contact with the substrate upon engaging the article with the device.

For controlling the temperature of the substrate, multi-layer susceptor arrangements have been proposed which comprise a first layer and a second layer firmly bound together. While the first layer comprises a first susceptor material being optimized with regard to heat loss and thus heating efficiency, the second layer comprises a second susceptor material being used as temperature marker. For this, the second susceptor material is a magnetic (ferro-or ferrimagnetic) material and chosen such as to have a Curie temperature corresponding to a predefined temperature point for heating the substrate. At its Curie temperature, the magnetic permeability of the second susceptor material drops to unity leading to a change of its magnetic properties from ferro-or ferrimagnetic to paramagnetic. The change of the magnetic properties is accompanied by a temporary change of the electrical resistance of the susceptor arrangement. Thus, by monitoring a corresponding change of the electrical current through the induction source it can be detected when the second susceptor material has reached its Curie temperature and, thus, when the predefined temperature point has been reached.

Depending on the specific compositions of the first and second susceptor, such susceptor arrangements may be subject to material diffusion from the susceptor materials into the aerosol-forming substrate, as well as subject to material aging, in particular corrosion. In addition, depending on the material pairing resulting from the specific materials of the first and second layer, such susceptor arrangements may be subject to changes in the magnetic properties of the susceptor materials as well as to thermal bending due to differences in thermal dilatation between the layers.

Therefore, it would be desirable to have a susceptor arrangement for inductively heating aerosol-forming substrates with the advantages of prior art solutions, whilst mitigating their limitations. In particular, it would be desirable to have a susceptor arrangement and an aerosol-generating article including such a susceptor arrangement which has improved characteristics at least with respect to material diffusion from the susceptor materials into the aerosol-forming substrate and material aging.

According to the invention there is provided a multi-layer susceptor arrangement for inductively heating an aerosol-forming substrate, the susceptor arrangement comprising or consisting of a first layer comprising or consisting of a first susceptor material, a second layer comprising or consisting of a second susceptor material, and a third layer comprising or consisting of a third material. The second layer is sandwiched between the first layer and the third layer. The second susceptor material comprises or consists of a Ni-Fe-alloy having a Ni content of equal to or smaller than 65 wt %. A layer thickness of the third layer is equal to or smaller than 50 % of a layer thickness of the first layer.

According to the invention it has been found that the characteristics of the susceptor arrangement can already be easily improved by adding a third layer to the second layer opposite to the first layer such the second layer is sandwiched between the first layer and the third layer. Thus, the third layer may serve as a protective layer configured to at least one of: avoid material diffusion, for example metal migration, from the second susceptor material into the aerosol-forming substrate, or protect other layers, in particular the second layer, from aging, e.g. from corrosive influences. Both aspects are particularly important, where the susceptor arrangement is intended to be embedded in an aerosol-forming substrate of an aerosol-generating article, that is, where the susceptor arrangement is intended for arrangement in direct physical contact with the aerosol-forming substrate.

In particular, the third layer allows the composition of the second susceptor material to be chosen more selectively and freely with respect to its magnetic properties, especially with respect to a desired Curie temperature, while being less constrained by limitations related to material aging and material diffusion. For example, the third layer allows to deliberately chosen a less corrosion-resistant material as temperature marker material in the second layer, but one that has a desired Curie temperature close or equal to a predefined temperature point for heating the substrate.

According to the invention, it has been further found that the layer thickness of the third layer can be relatively small, namely, equal to or smaller than 50% of a layer thickness of the first layer, while still properly protecting the second layer. A small third layer thickness proves beneficial not only in terms material savings, but also in that the second layer is less shielded from the alternating magnetic field of the induction source used to inductively heat the susceptor arrangement. As a result, when using the second susceptor material as a temperature maker, the effect of the above-described change in the magnetic properties of the second susceptor material at about its Curie temperature on the electrical current through the induction source is more pronounced. Advantageously, this makes it possible to determine more reliably when the second susceptor material has reached its Curie temperature and, thus, when the predefined temperature point has been reached.

As used herein, the term “thickness” refers to any dimensions extending between the top and the bottom side, for example between a top side and a bottom side of a layer or a top side and a bottom side of the multi-layer susceptor arrangement.

Basically, the lower the layer thickness of the third layer, the higher the material savings and the more reliable the temperature monitoring. Accordingly, the layer thickness of the third layer may be equal to or smaller than 45%, in particular equal to or smaller than 40%, more particularly equal to or smaller than 35%, preferably equal to or smaller than 30%, more preferably equal to or smaller than 25%, even more preferably equal to or smaller than 20%, most preferably equal to or smaller than 15%, or preferably equal to or smaller than 10% of the layer thickness of the first layer.

In absolute terms, the layer thickness of the third layer may be equal to or smaller than 8 micrometer, in particular equal to or smaller than 7 micrometer, more particularly equal to or smaller than 6 micrometer, preferably equal to or smaller than 5 micrometer, or equal to or smaller than 4 micrometer, or equal to or smaller than 3 micrometer.

As used herein, the term “susceptor material” refers to a material that is capable to convert field energy into heat when subjected to an alternating magnetic field. This may be the result of at least one hysteresis losses and eddy currents induced in the susceptor material, depending on its electrical and magnetic properties. Hysteresis losses occur in ferromagnetic or ferrimagnetic susceptor materials due to magnetic domains within the material being switched under the influence of an alternating magnetic field. Eddy currents may be induced, if the susceptor material is electrically conductive. In case of an electrically conductive ferromagnetic susceptor or an electrically conductive ferrimagnetic susceptor, heat can be generated due to both, eddy currents and hysteresis losses.

As described above, the first layer including the first susceptor material preferably servers as the primary susceptor for heating the aerosol-forming substrate. For this, the first susceptor material may be optimized with regard to heat loss and thus heating efficiency.

At least a portion of an outer surface of the first layer may be unprotected, that is, bare, exposed to or in direct contact with the environment. In particular in case the susceptor arrangement is embedded in an aerosol-forming substrate, at least a portion of an outer surface of the first layer may be exposed to and in direct physical contact with the aerosol-forming substrate. Advantageously, this allows for a good heat transfer to the aerosol-forming substrate which is preferably and primarily to be heated by the first layer. Preferably, all portions of an outer surface of the first layers, unless in intimate physical contact with other layers, in particular the second layer, are unprotected, bare or exposed to the environment. Advantageously, this ensures maximum heat transfer to the aerosol-forming substrate.

The first susceptor material may be at least one of electrically conductive and magnetic, that is, either ferromagnetic or ferrimagnetic. If the first susceptor material is electrically conductive, it may also be paramagnetic. In case the first susceptor material is magnetic (ferromagnetic or ferrimagnetic), it is preferably chosen such as to have a Curie temperature that is distinct from, in particular higher than a Curie temperature of the second susceptor material. In this specific configuration, the first susceptor material may have a first Curie temperature and the second susceptor material may have a second Curie temperature.

Preferably, the first susceptor material is made of an anti-corrosive material. Thus, the first susceptor material is advantageously resistant to any corrosive influences itself.

Preferably, the first susceptor material comprises or consists of a metal, for example ferritic iron, or stainless steel, in particular ferromagnetic stainless steel, for example ferritic stainless steel. It may be particularly preferred that the first susceptor material comprises or consists of a 400 series stainless steel such as a grade 410 stainless steel, or a grade 420 stainless steel, or a grade 430 stainless steel, or stainless steel of similar grades.

The first susceptor material may alternatively comprise or consist of a suitable non-magnetic, in particular paramagnetic, conductive material, such as aluminum (Al). In a paramagnetic conductive material inductive heating occurs solely by resistive heating due to eddy currents.

Alternatively, the first susceptor material may comprise or consist of a non-conductive ferrimagnetic material, such as a non-conductive ferrimagnetic ceramic. In that case, heat is only by generated by hysteresis losses.

As also mentioned above, the second susceptor material preferably serves as a temperature marker. That is, the second susceptor material preferably is configured for monitoring a temperature of the susceptor arrangement. For this, the second susceptor material may be selected to have a Curie temperature which essentially corresponds to a predefined temperature point of the heating process. In particular, the second susceptor material may be selected to have a Curie temperature which essentially corresponds to a predefined maximum heating temperature of the susceptor arrangement. The maximum desired heating temperature may be defined to be approximately the temperature that the susceptor arrangement should be heated to in order to generate an aerosol from the aerosol-forming substrate. However, the maximum desired heating temperature should be low enough to avoid local overheating or even burning of the aerosol-forming substrate. Preferably, the Curie temperature of the second susceptor material should be below an ignition point of the aerosol-forming substrate to be heated. The second susceptor material, in particular the Ni-Fe-alloy of the second susceptor material may have a Curie temperature below 500° C., preferably equal to or below 400° C., in particular equal to or below 390° C. For example, the second susceptor, in particular the Ni-Fe-alloy of the second susceptor material may have a Curie temperature in a range between 180° C. and 420° C., in particular between 210° C. and 380° C., preferably between 250° C. and 380° C. Even though the second layer primarily may be a functional layer providing a temperature marker by the Curie temperature of the second susceptor material, it may also contribute to the inductive heating of the susceptor arrangement. Yet, it is preferably the first layer including the first susceptor material which is configured for heating the aerosol-forming substrate primarily.

As defined above, the second susceptor material comprises or consists of a Ni-Fe-alloy having a Ni content of equal to or smaller than 65 wt %. As used herein, the unit “wt %” stands for “weight per cent” or “percentage by weight” . That is, it denotes the mass fraction of an element within the alloy which is the ratio of the mass of that respective element to the total mass of a sample of that alloy.

Advantageously, most Ni-Fe-alloys with a Ni content of equal to or smaller than 65 wt % have a Curie temperature in a range below 600° C. and are thus well suited as temperature markers for a large range of heat-not-burn substrates most of which have an ignition point above 600° C. In addition, most Ni-Fe-alloys with Ni content of 65 wt % or less still have a sufficiently large magnetic permeability such that the magnetic permeability shows a clearly detectable drop when the temperature of the material reaches the Curie point.

It is also possible that the Ni content is well below 65 wt %. Accordingly, the Ni-Fe-alloy of the second susceptor material may have a Ni content of equal to or smaller than 50 wt %, in particular equal to or smaller than 44 wt %, more particularly a Ni content in range between 36 wt % and 44 wt %, preferably in a range between 36 wt % and 40 wt %, for example 36.1 wt % or 36.4 wt % or 40 wt %; the rest preferably being Fe.

The Ni-Fe-alloy of the second susceptor material may be a binary Ni-Fe alloy, that is a Ni-Fe allow consisting of Ni and Fe only.

Alternatively, the Ni-Fe alloy may comprise one or more of the following elements: Co, Cr, Cu, Mn, Mo, Nb, Si, Ti and V.

As used herein, the symbol Ni stands for the chemical element nickel, the symbol Fe stands for the chemical element iron, the symbol Co stands for the chemical element cobalt, the symbol Cr stands for the chemical element chromium, the symbol Cu stands for the chemical element copper, the symbol Mn stands for the chemical element manganese, the symbol Mo stands for the chemical element molybdenum, the symbol Nb stands for the chemical element niobium, the symbol Si stands for the chemical element silicon, the symbol Ti stands for the chemical element titanium, and the symbol V stands for the chemical element vanadium.

Advantageously, the Curie temperature of a Ni-Fe alloy may be selectively adjusted by adding chromium. Accordingly, the Ni-Fe alloy of the second susceptor material may additionally comprise chromium. In particular, the second susceptor material may comprise or consist of a Ni-Fe-Cr alloy. The higher the chromium content, the lower the Curie temperature of the alloy. In addition, adding chromium has an impact on the corrosion resistance of the Ni-Fe alloy. In general, the corrosion resistance may be enhanced by increasing the chromium content. As a specific example, the Ni-Fe-alloy of the second susceptor material may further comprise 8 wt % 12 wt % Cr, in particular 9 wt %-11 wt % Cr. Depending on the actual Ni content, the Curie temperature of a Ni-Fe alloy additionally comprising comprise 8 wt %-12 wt % Cr, in particular 9 wt %-11 wt % Cr may be advantageously tuned to be in a range between 200° C. and 300° C.

According to one example, the Ni-Fe-alloy may comprise or consist of 50 wt % Ni, 9 wt % Cr, the rest being Fe. This alloy may be commercially available, for example, under the tradename Phytherm 260 and has a Curie temperature of 260° C. According to another example, the Ni-Fe-alloy may comprise or consist of 50 wt % Ni, 10 wt % Cr, the rest being Fe. This alloy is also commercially available, for example, under the tradename Phytherm 220 and has a Curie temperature of 230° C. According to yet another example, the Ni-Fe-alloy may comprise or consist of 50 wt % Ni, 11 wt % Cr, the rest being Fe. This alloy is also commercially available, for example, under the tradename Phytherm 210 and has a Curie temperature of 210° C. Advantageously, all of the aforementioned alloys (Phytherm alloys) are anti-corrosive materials.

The Ni-Fe-alloy may also comprise one or more further elements in addition to chromium.

According to an example, the Ni-Fe-alloy of the second susceptor material may comprise or consist of 50 wt % Ni, 9 wt % Cr, up to 1 wt % Si and up to 1 wt % Mn, the rest being Fe. According to another example, the Ni-Fe-alloy of the second susceptor material may comprise or consist of 50 wt % Ni, 10 wt % Cr, up to 1 wt % Si and up to 1 wt % Mn, the rest being Fe. According to yet another example, the Ni-Fe-alloy of the second susceptor material may comprise or consist of 50 wt % Ni, 11 wt % Cr, up to 1 wt % Si and up to 1 wt % Mn, the rest being Fe.

As mentioned above, the Ni-Fe-alloy of the second susceptor material may have a Ni content even smaller than 50 wt %. In particular, the Ni-Fe-alloy of the second susceptor material may have a Ni content equal to or smaller than 44 wt %, more particularly a Ni content in a range between 36 wt % and 44 wt %, preferably in a range between 36 wt % and 40 wt %, for example 36.1 wt % or 36.4 wt % or 40 wt %; the rest preferably being Fe. As an example, the Ni-Fe-alloy may be an alloy available from Hitachi under name “MS-10”, which has a Ni content of 36.1 wt % and a Curie temperature of 213° C. Likewise, the Ni-Fe-alloy may be an alloy available from Hitachi under name “MS-16”, which has a Ni content of 36.4 wt % and a Curie temperature of 221.5° C.

As used herein, the term “third layer” refers to a layer in addition to the first and second layers that is different from the first and second layer. In particular, any possible oxide layer on a surface of the first or second layer resulting from oxidation of the first or second susceptor material is not to be considered a third layer, in particular not a third layer comprising or consisting of an anti-corrosive material.

Preferably, the third material is an anti-corrosive material. Advantageously, the anti-corrosive material improves the aging characteristics of those portions of the outer surface of the second layer which are covered by the third layer and thus not directly exposed to the environment.

The third layer may comprise or consist of a material identical to the first susceptor material of the first layer. That is, the third material may be identical to the first susceptor material. Due to this, the multi-layer susceptor arrangement comprises at least two layers having the same coefficient of thermal expansion which results in reduced deformations of the susceptor arrangement through the temperature range of operation. This applies in particular where the susceptor arrangement only comprises the first, second and third layer such that the second layer is symmetrically sandwiched between the first and third layer.

Alternatively, the third material may be different from the first susceptor material. In this way, the properties of the first and third layers can be selected independently to achieve an optimum for their respective purposes.

In particular where the third material is identical to the first susceptor material, the third material may comprise or consist of a metal, for example ferritic iron, or stainless steel, for example ferritic stainless steel, in particular a 400 series stainless steel such as grade 410 stainless steel, or grade 420 stainless steel, or grade 430 stainless steel, or stainless steel of similar grades.

Alternatively, the third material may comprise or consist of a suitable non-magnetic, in particular paramagnetic, conductive material, such as aluminum (Al). Likewise, the third material may comprise or consist a non-conductive ferrimagnetic material, such as a non-conductive ferrimagnetic ceramic.

It is also possible that the third material may comprise or consist of an austenitic stainless steel. Advantageously, due to its paramagnetic characteristics and high electrical resistance, austenitic stainless steel only weakly shields the second layer from the magnetic field to be applied to the first and second susceptor material. As an example, the third material may comprise or consist of X5CrNi18-10 (according to EN (European Standards) nomenclature, material number 1.4301, also known as V2A steel) or X2CrNiMo17-12-2 (according to EN (European Standards) nomenclature, material number 1.4571 or 1.4404, also known as V4A steel). In particular, the third material may comprise or consist of one of 301 stainless steel, 304 stainless steel, 304L stainless steel, 316 stainless steel or 316L stainless steel (nomenclature according to SAE steel grades [Society of Automotive Engineers]).

As already mentioned above, the layer thickness of the third layer in absolute values may be equal to or smaller than 8 micrometer, in particular equal to or smaller than 7 micrometer, more particularly equal to or smaller than 6 micrometer, preferably equal to or smaller than 5 micrometer, or equal to or smaller than 4 micrometer, or equal to or smaller than 3 micrometer. Vice versa, the third layer should not be too thin in order properly fulfill its protective function. In particular, if the third layer was too thin, it could be fragile and tend to break down. Accordingly, the layer thickness of the third layer may be at least 0.75 micrometer, in particular at least 1 micrometer.

Given the above-mentioned upper and lower limits, it may be advantageous, if the layer thickness of the third layer preferably is in range between 0.75 micrometer and 8 micrometer, in particular between 1 micrometer and 5 micrometer, more particularly between 2 micrometer and 4 micrometer, for example 3.5 micrometer.

A layer thickness of the first layer may be in range between 20 micrometer and 60 micrometer, in particular between 30 micrometer and 50 micrometer, for example 40 micrometer or 42.5 micrometer.

Likewise, a layer thickness of the second layer may be in range between 4 micrometer and 20 micrometer, in particular between 8 micrometer and 18 micrometer, preferably between 10 micrometer and 16 micrometer, for example 10 micrometer or 14 micrometer.

In relative terms, a layer thickness of the first layer may be in a range between 1.5 and 5, in particular between 2 and 4, preferably between 2.5 and 3.5, more preferably about 3, times the layer thickness of the second layer. To this extent, it has been found that the layer thickness of the second layer does not need be very large as compared to the first layer, i.e. that the temperature marker layer does not need be very large as compared to the primary heating layer. Likewise, the third layer may be equal to or smaller than 70%, in particular equal to or smaller than 60%, more particularly equal to or smaller than 50%, even more particularly equal to or smaller than 45%, preferably equal to or smaller than 40%, more preferably equal to or smaller than 35%, even more preferably equal to or smaller than 30%, most preferably equal to or smaller than 25% of the second layer.

As defined above, the second layer is sandwiched between the first and the third layer. This does not necessarily mean that the first, the second and the third layers are adjacent layers. That is, there may be one or more additional layers between the first and the second layer and/or the second and the third layer and/or on top of the third layer opposite to the second layer and/or below the first layer opposite to the second layer.

Yet it is preferred that the first, the second and the third layers are directly adjacent layers of the multi-layer susceptor arrangement, in particular in direct physical contact with each other. At least one of the first layer or the third layer may be an edge layer of the multi-layer susceptor arrangement.

More particularly, the multi-layer susceptor arrangement may consists of the first layer, the second layer and the third layer only. That is, the multi-layer susceptor arrangement preferably is a three-layer susceptor arrangement.

Where the first layer and the second layer are directly adjacent layers, the second layer may be intimately coupled to the first layer, in particular on top of the first layer. Likewise, where the second layer and the third layer are directly adjacent layers, the third layer may be intimately coupled to the second layer, in particular on top of the second layer.

With regard to the processing of the susceptor arrangement, in particular with regard to the assembly of the various layers, each of the layers may be plated, deposited, coated, cladded or welded onto a respective adjacent layer. In particular, each of these layers may be applied onto a respective adjacent layer by spraying, dip coating, roll coating, electroplating or cladding. This holds in particular for the first layer, the second layer and the third layer and—if present—the at least one additional layer. Either way, any of the configurations or layer structures described above falls within the term “intimately coupled” as used herein.

In general, the multi-layer susceptor arrangement may have various shapes. In particular, susceptor arrangement has the form of a blade or a strip or a sheet. Preferably, the multi-layer susceptor arrangement may be an elongate, in particular strip-like, susceptor arrangement.

An overall thickness of the susceptor arrangement may be in a range between 24 micrometer and 88 micrometer, in particular between 50 micrometer and 65 micrometer, preferably between 54 micrometer and 62 micrometer, for example 56 micrometer or 60 micrometer.

A width of the susceptor arrangement in a direction perpendicular to an overall thickness of the susceptor arrangement may be in a range between 3 millimeter and 7 millimeter, in particular between 4 millimeter and 6 millimeter, for example 5 millimeter.

A length of the susceptor arrangement in a direction perpendicular to an overall thickness of the susceptor arrangement may be in a range between 10 millimeter and 15 millimeter, in particular between 11 millimeter and 13 millimeter, for example 12 millimeter

As used herein, the term “thickness” refers to any dimensions extending between the top and the bottom side, for example between a top side and a bottom side of a layer or a top side and a bottom side of the multi-layer susceptor arrangement. Likewise, the term “width” is used herein to refer to any dimensions extending between two opposed lateral sides of a layer or the susceptor arrangement. The term “length” is used herein to refer to any dimensions extending between the front and the back or between other two opposed sides orthogonal to the two opposed lateral sides forming the width. Preferably, a width extension is larger than a thickness extension. Likewise, a width extension may be smaller than a length extension. Thickness, width and length may be orthogonal to each other.

According to another aspect of the invention there is provided a two-layer susceptor arrangement for inductively heating an aerosol-forming substrate, the susceptor arrangement consisting of a first layer comprising or consisting of a first susceptor material, and a second layer comprising or consisting of a second susceptor material, wherein the first layer and the second layer are intimately coupled to each other, wherein the second susceptor material comprises or consists of a Ni-Fe-alloy having a Ni content of equal to or smaller than 65wt % and a Cr content of equal to or greater than 13wt %, and wherein a layer thickness of the second layer is in a range between 1 micrometer and 22 micrometer.

In accordance with this aspect of the invention, it has been found that a Ni-Fe-alloy having a Ni content of equal to or smaller than 65wt % and a Cr content of equal to or greater than 13 wt % provides sufficient resistance to corrosion due to its chemical composition, chiefly the chromium content, such that a protective layer on top of the second layer (opposite the first layer) can be omitted. This proves beneficial in terms material savings. The resistance to corrosion results from the relatively high chromium content, which undergoes passivation by reaction with oxygen, thus forming a passive, microscopically thin inert surface film of chromium oxide. This passive film prevents further corrosion by blocking oxygen diffusion to the second layer surface and thus prevents corrosion from spreading into the bulk of the metal. The passive film is self-repairing, even when scratched or temporarily disturbed by an upset condition in the environment. Preferably, the layer thickness of the second layer of the two-layer susceptor arrangement may be in a range between 1 micrometer and 15 micrometer, in particular between 4 micrometer and 15 micrometer or between 1 micrometer and 11 micrometer, more particularly between 4 micrometer and 11 micrometer. The layer thickness of the first layer of the two-layer susceptor arrangement may be in a range between 20 micrometer and 60 micrometer, in particular between 30 micrometer and 50 micrometer, for example 40 micrometer or 42.5 micrometer. An overall thickness of the two-layer susceptor arrangement may be in a range between 21 micrometer and 75 micrometer or between 21 micrometer and 82 micrometer, in particular between 24 micrometer and 71 micrometer, more particularly between 44 micrometer and 55 micrometer.

According to the invention there is also provided an inductively heatable aerosol-generating article comprising at least one aerosol-forming substrate and a multi-layer susceptor arrangement according to the present invention and as described herein.

As used herein, the term “aerosol-generating article” refers to an article comprising at least one aerosol-forming substrate capable of releasing volatile compounds when heated which can form an aerosol. Preferably, the aerosol-generating article is a heated aerosol-generating article, that is, an aerosol-generating article which comprises at least one aerosol-forming substrate that is intended to be heated rather than combusted. Such an article may be denoted as a heat-not-burn aerosol-generating article, and the substrate may be denoted as a heat-not-burn aerosol-forming substrate. The aerosol-generating article may be a consumable, in particular a consumable to be discarded after a single use. The aerosol-generating article may be a tobacco article. For example, the article may be a cartridge including a liquid aerosol-forming substrate to be heated. As another example, the article may be an elongate article or a rod-shaped article. The elongate or rod-shaped article may have a shape resembling the shape of conventional cigarettes. In particular, such an article may have a circular or elliptical or oval or square or rectangular or triangular or a polygonal cross-section.

As used herein, the term “aerosol-forming substrate” denotes a substrate formed from or comprising an aerosol-forming material that is capable of releasing volatile compounds upon heating in order to generate an aerosol. Preferably, the aerosol-forming substrate is intended to be heated rather than combusted in order to release the aerosol-forming volatile compounds. The aerosol-forming substrate may be a solid aerosol-forming substrate, a liquid aerosol-forming substrate, a gel-like aerosol-forming substrate, or any combination thereof. For example, the aerosol-forming substrate may comprise both solid and liquid components. The aerosol-forming substrate may comprise a tobacco-containing material containing volatile tobacco flavor compounds, which are released from the substrate upon heating. Alternatively or additionally, the aerosol-forming substrate may comprise a non-tobacco material. The aerosol-forming substrate may further comprise an aerosol former. Examples of suitable aerosol formers are glycerin and propylene glycol. The aerosol-forming substrate may also comprise other additives and ingredients, such as nicotine or flavourants. The aerosol-forming substrate may also be a paste-like material, a sachet of porous material comprising aerosol-forming substrate, or, for example, loose tobacco mixed with a gelling agent or sticky agent, which could include a common aerosol former such as glycerin, and which is compressed or molded into a plug.

Preferably, the multi-layer susceptor arrangement is embedded in the aerosol-forming substrate.

As an example, the aerosol-generating article may be a rod-shaped article. In particular a cylindrical article comprising one or more of the following elements: a distal front plug element, a substrate element, a first tube element, a second tube element, and a filter element.

The substrate element preferably comprises the at least one aerosol-forming substrate to be heated and the susceptor arrangement in thermal contact with or thermal proximity to the aerosol-forming substrate. The substrate element may have a length of 10 millimeter to 14 millimeter, for example, 12 millimeter. The susceptor arrangement may extend along the entire length of the substrate element or may have a length extension shorter than the length of the substrate element.

The first tube element is more distal than the second tube element. Preferably, the first tube element is proximal of the substrate element, whereas the second tube element is proximal of the first tube element and distal of the filter element, that is, between the first tube element and the filter element. At least one of the first tube element and the second tube element may comprise a central air passage. A cross-section of the central air passage of the second tube element may be larger than a cross-section of the central air passage of the first tube element. Preferably, at least one of the first tube element and the second tube element may comprise a hollow cellulose acetate tube. At least one of the first tube element and the second tube element may have a length of 6 millimeter to 10 millimeter, for example, 8 millimeters.

The filter element preferably serves as a mouthpiece, or is part of a mouthpiece together with the second tube element. As used herein, the term “mouthpiece” refers to a portion of the article through which the aerosol exits the aerosol-generating article. The filter element may have a length of 10 millimeter to 14 millimeter, for example, 12 millimeter.

The distal front plug element may be used to cover and protect the distal front end of the substrate element. The distal front plug element may have a length of 3 millimeter to 6 millimeter, for example, 5 millimeter. The distal front plug element may be made of the same material as the filter element

All of the aforementioned elements may be sequentially arranged along a length axis of the article in the above described order, wherein the distal front plug element preferably is arranged at a distal end of the article and the filter element preferably is arranged at a proximal end of the article. Each of the aforementioned elements may be substantially cylindrical. In particular, all elements may have the same outer cross-sectional shape and/or dimensions.

In addition, the elements may be circumscribed by one or more outer wrappers such as to keep the elements together and to maintain the desired cross-sectional shape of the rod-shaped article. Preferably, the wrapper is made of paper. The wrapper may further comprise adhesive that adheres the overlapped free ends of the wrapper to each other. For example, the distal front plug element, the substrate element and the first tube element may be circumscribed by a first wrapper, and the second tube element and the filter element may be circumscribed by a second wrapper. The second wrapper may also circumscribe at least a portion of the first tube element (after being wrapped by the first wrapper, i.e. on top of the first wrapper) to connect the distal front plug element, the substrate element and the first tube element being circumscribed by a first wrapper to the second tube element and the filter element. The second wrapper may comprise perforations around its circumference.

Further features and advantages of the aerosol-generating article according to the present invention have already been described above with regard to the susceptor arrangement according to the present invention and equally apply.

According to one aspect of the present invention, there is also provided an aerosol-generating system comprising an inductively heatable aerosol-generating article according to the present invention and as described herein, as well as an inductively heating aerosol-generating device for use with the aerosol-generating article.

According to another aspect of the present invention, there is provided an aerosol-generating system comprising an inductively heating aerosol-generating device and an aerosol-generating article for use with the aerosol-generating device, wherein the aerosol-generating device comprises a multi-layer susceptor arrangement according to the present invention and as described herein, and wherein the aerosol-generating article comprises an aerosol-forming substrate to be heated by the multi-layer susceptor arrangement.

That is, according to the one aspect of the invention (first configuration of the system), the susceptor arrangement is part of the aerosol-generating article, whereas according to the other aspect of the invention (second configuration of the system), the susceptor arrangement is part of the aerosol-generating device.

As used herein, the term “aerosol-generating device” describes in either configuration an electrically operated device for interaction with an aerosol-generating article in order to generate an aerosol by heating the aerosol-forming substrate via interaction of the susceptor arrangement with an alternating magnetic field provided by the aerosol-generating device. Preferably, the aerosol-generating device is a puffing device for generating an aerosol that is directly inhalable by a user through the user's mouth. In particular, the aerosol-generating device is a hand-held aerosol-generating device.

In either configuration of the system, the device may comprise a receiving cavity for removably receiving at least a portion of the respective aerosol-generating article.

In either configuration of the system, the aerosol-generating device may comprise an inductive heating arrangement configured and arranged to generate an alternating magnetic field in the receiving cavity in order to inductively heat the susceptor arrangement.

For generating the alternating magnetic field, the inductive heating arrangement may comprise at least one induction coil surrounding at least a portion of the susceptor arrangement in use of the system. The at least one induction coil may be a helical coil or flat planar coil, in particular a pancake coil or a curved planar coil. In the first configuration, the aerosol-generating device and the aerosol-generating article preferably are configured such that the susceptor arrangement is arranged within the cavity of the device, in particular within an interior space of the at least one induction coil, such as to experience the alternating magnetic field, when the article is received in the aerosol-generating device. Likewise, in the second configuration, the susceptor arrangement preferably is fixedly arranged within the cavity of the device, in particular within an interior space of the at least one induction coil, such as to experience the alternating magnetic field.

The inductive heating arrangement may further comprise an alternating current (AC) generator. The AC generator may be powered by a power supply of the aerosol-generating device. The AC generator is operatively coupled to the at least one induction coil. In particular, the at least one induction coil may be integral part of the AC generator. The AC generator is configured to generate a high frequency oscillating current to be passed through the at least one induction coil for generating an alternating magnetic field. The AC current may be supplied to the at least one induction coil continuously following activation of the system or may be supplied intermittently, such as on a puff by puff basis. Preferably, the inductive heating arrangement comprises a DC/AC converter including an LC network, wherein the LC network comprises a series connection of a capacitor and the inductor. The DC/AC converter may be connected to a DC power supply.

The inductive heating arrangement preferably is configured to generate a high-frequency magnetic field. As referred to herein, a frequency of the high-frequency magnetic field may be in a range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz).

In either configuration of the system, the aerosol-generating device may further comprise a controller configured to control operation of the heating process. The controller may be or may be part of an overall controller of the aerosol-generating device. The controller may comprise a microprocessor, for example a programmable microprocessor, a microcontroller, or an application specific integrated chip (ASIC) or other electronic circuitry capable of providing control. The controller may comprise further electronic components, such as at least one DC/AC converter and/or power amplifiers, for example a Class-C power amplifier or a Class-D power amplifier or Class-E power amplifier. In particular, the induction source may be part of the controller.

In either configuration of the system, the aerosol-generating device may also comprise a power supply, in particular a DC power supply configured to provide a DC supply voltage and a DC supply current to the induction source. Preferably, the power supply is a battery such as a lithium iron phosphate battery. The power supply may be rechargeable. The power supply may have a capacity that allows for the storage of enough energy for one or more user experiences. For example, the power supply may have sufficient capacity to allow for the continuous generation of aerosol for a period of around six minutes or for a period that is a multiple of six minutes. In another example, the power supply may have sufficient capacity to allow for a predetermined number of puffs or discrete activations of the induction source.

Further features and advantages of the aerosol-generating system according to either aspect of the invention have been described with regard to the susceptor arrangement and the aerosol-generating article and thus equally apply.

The invention is defined in the claims. However, below there is provided a non-exhaustive list of non-limiting examples. Any one or more of the features of these examples may be combined with any one or more features of another example, embodiment, or aspect described herein.

Example Ex1: A multi-layer susceptor arrangement for inductively heating an aerosol-forming substrate, the susceptor arrangement comprising or consisting of
a first layer comprising or consisting of a first susceptor material,
a second layer comprising or consisting of a second susceptor material, and
a third layer comprising or consisting of a third material, wherein the second layer is sandwiched between the first layer and the third layer, wherein the second susceptor material comprises or consists of a Ni-Fe-alloy having a Ni content of equal to or smaller than 65 wt %, and wherein a layer thickness of the third layer is equal to or smaller than 50% of a layer thickness of the first layer.

Example Ex2: The multi-layer susceptor arrangement according to example Ex1, wherein the layer thickness of the third layer is equal to or smaller than 45%, in particular equal to or smaller than 40%, more particularly equal to or smaller than 35%, preferably equal to or smaller than 30%, more preferably equal to or smaller than 25%, even more preferably equal to or smaller than 20%, most preferably equal to or smaller than 15%, or preferably equal to or smaller than 10% of the layer thickness of the first layer.

Example Ex3: The multi-layer susceptor arrangement according to any one of the preceding examples, wherein a layer thickness of the first layer is in a range between 1.5 and 5, in particular between 2 and 4, preferably between 2.5 and 3.5, more preferably about 3, times the layer thickness of the second layer.

Example Ex4: The multi-layer susceptor arrangement according to any one of the preceding examples, wherein the first susceptor material comprises or consists of a metal, for example ferritic iron, or stainless steel, in particular a grade 410, grade 420, or grade 430 stainless steel.

Example Ex5: The multi-layer susceptor arrangement according to any one of the preceding examples, wherein the Ni-Fe-alloy of the second susceptor material further comprises 8 wt %-12 wt % Cr, in particular 9 wt %-11 wt % Cr.

Example Ex6: The multi-layer susceptor arrangement according to any one of examples Ex1 to Ex5, wherein the Ni-Fe-alloy of the second susceptor material has a Ni content of equal to or smaller than 50 wt %, in particular equal to or smaller than 44 wt %, more particularly a Ni content in range between 36 wt % and 44 wt %, preferably in a range between 36 wt % and 40 wt %, for example 36.1 wt % or 36.4 wt % or 40 wt %; the rest preferably being Fe.

Example Ex7: The multi-layer susceptor arrangement according to any one of examples Ex1 to Ex5, wherein the Ni-Fe-alloy of the second susceptor material comprises or consists of one of:
50 wt % Ni, 9 wt % Cr, the rest being Fe;
50 wt % Ni, 10 wt % Cr, the rest being Fe;
50 wt % Ni, 11 wt % Cr, the rest being Fe;
50 wt % Ni, 9 wt % Cr, up to 1 wt % Si and up to 1 wt % Mn, the rest being Fe;
50 wt % Ni, 10 wt % Cr, up to 1 wt % Si and up to 1 wt % Mn, the rest being Fe;
50 wt % Ni, 11 wt % Cr, up to 1 wt % Si and up to 1 wt % Mn, the rest being Fe.

Example Ex8: The multi-layer susceptor arrangement according to any one of the preceding examples, wherein the Ni-Fe-alloy of the second susceptor material has a Curie temperature in a range between 180° C. and 420° C., in particular between 210° C. and 380° C., preferably between 250° C. and 380° C.

Example Ex9: The multi-layer susceptor arrangement according to any one of the preceding examples, wherein the third material is an anti-corrosive material.

Example Ex10: The multi-layer susceptor arrangement according to any one of examples Ex1 to Ex9, wherein the third material is identical to the first susceptor material.

Example Ex11: The multi-layer susceptor arrangement according to any one of examples Ex1 to Ex9, wherein the third material is different from the first susceptor material.

Example Ex12: The multi-layer susceptor arrangement according to any one of the preceding examples, wherein a layer thickness of the first layer is in range between 20 micrometer and 60 micrometer, in particular between 30 micrometer and 50 micrometer, for example 40 micrometer or 42.5 micrometer.

Example Ex13: The multi-layer susceptor arrangement according to any one of the preceding examples, wherein a layer thickness of the second layer is in range between 4 micrometer and 20 micrometer, in particular between 8 micrometer and 18 micrometer, preferably between 10 micrometer and 16 micrometer, for example 10 micrometer or 14 micrometer.

Example Ex14: The multi-layer susceptor arrangement according to any one of the preceding examples, wherein the layer thickness of the third layer is equal to or smaller than 8 micrometer, in particular equal to or smaller than 7 micrometer, more particularly equal to or smaller than 6 micrometer, preferably equal to or smaller than 5 micrometer, or equal to or smaller than 4 micrometer, or equal to or smaller than 3 micrometer.

Example Ex15: The multi-layer susceptor arrangement according to any one of the preceding examples, wherein the layer thickness of the third layer is at least 0.75 micrometer, in particular at least 1 micrometer.

Example Ex16: The multi-layer susceptor arrangement according to any one of the preceding examples, wherein the layer thickness of the third layer is in range between 0.75 micrometer and 8 micrometer, in particular between 1 micrometer and 5 micrometer, preferably between 2 micrometer and 4 micrometer, for example 3.5 micrometer.

Example Ex17: The multi-layer susceptor arrangement according to any one of the preceding examples, wherein the second layer is intimately coupled to the first susceptor, in particular on top of the first layer.

Example Ex18: The multi-layer susceptor arrangement according to any one of the preceding examples, wherein the third layer is intimately coupled to the second layer, in particular on top of the second layer.

Example Ex19: The multi-layer susceptor arrangement according to any one of the preceding examples, wherein the first layer, the second layer and the third layer are directly adjacent layers of the multi-layer susceptor arrangement.

Example Ex20: The multi-layer susceptor arrangement according to any one of the preceding examples, wherein the susceptor arrangement has the form of a blade or a strip or a sheet.

Example Ex21: The multi-layer susceptor arrangement according to any one of the preceding examples, wherein an overall thickness of the susceptor arrangement is in a range between 24 micrometer and 88 micrometer, in particular between 50 micrometer and 65 micrometer, preferably between 54 micrometer and 62 micrometer, for example 56 micrometer or 60 micrometer.

Example Ex22: The multi-layer susceptor arrangement according to any one of the preceding examples, wherein a width of the susceptor arrangement in a direction perpendicular to an overall thickness of the susceptor arrangement is in a range between 3 millimeter and 7 millimeter, in particular between 4 millimeter and 6 millimeter, for example 5 millimeter.

Example Ex23: The multi-layer susceptor arrangement according to any one of the preceding examples, wherein a length of the susceptor arrangement in a direction perpendicular to an overall thickness of the susceptor arrangement is in a range between 10 millimeter and 15 millimeter, in particular between 11 millimeter and 13 millimeter, for example 12 millimeter.

Example Ex24: An inductively heatable aerosol-generating article comprising at least one aerosol-forming substrate and a multi-layer susceptor arrangement according to any one of the preceding examples.

Example Ex25: The aerosol-generating article according to example Ex24, wherein the multi-layer susceptor arrangement is embedded in the aerosol-forming substrate.

Example Ex26: An aerosol-generating system comprising an inductively heatable aerosol-generating article according to any one of examples Ex24 to Ex25, and an inductively heating aerosol-generating device for use with the aerosol-generating article.

Example Ex27: An aerosol-generating system comprising an inductively heating aerosol-generating device and an aerosol-generating article or use with the aerosol-generating device, wherein the aerosol-generating device comprises a multi-layer susceptor arrangement according to any one of examples Ex1 to Ex23, and the aerosol-generating article comprises an aerosol-forming substrate to be heated by the multi-layer susceptor arrangement.

Examples will now be further described with reference to the figures in which:

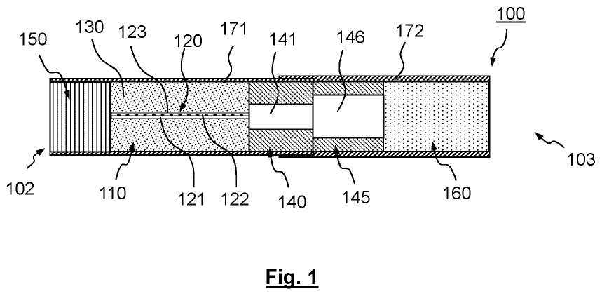

FIG. 1 schematically illustrates an exemplary embodiment of an inductively heatable aerosol-generating article comprising a multi-layer susceptor arrangement according to the present invention;

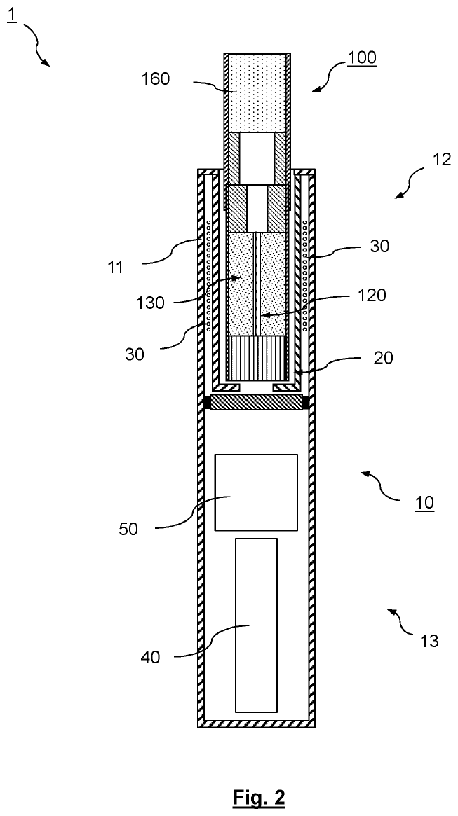

FIG. 2 schematically illustrates an exemplary embodiment of an aerosol-generating system comprising the aerosol-generating article according to FIG. 1;

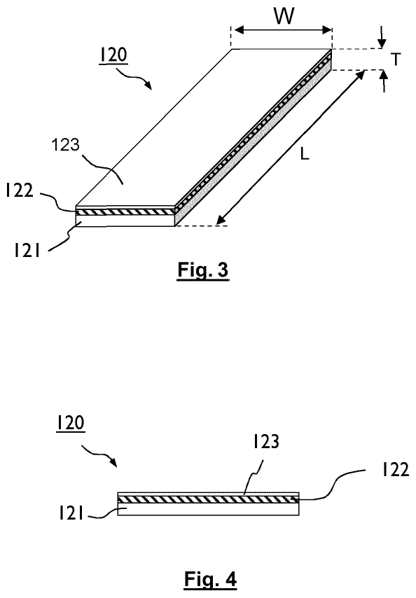

FIG. 3 shows details of the multi-layer susceptor arrangement of the aerosol-generating article according to FIG. 1 in a perspective view; and

FIG. 4 shows details of the multi-layer susceptor arrangement of the aerosol-generating article according to FIG. 1 in a cross-sectional view.

FIG. 1 schematically illustrates an exemplary embodiment of an inductively heatable aerosol-generating article 100 according to the present invention (not to scale). The aerosol-generating article 100 is a substantially rod-shaped consumable comprising five elements sequentially arranged in coaxial alignment: a distal front plug element 150, a substrate element 110, a first tube element 140, a second tube element 145, and a filter element 160. The distal front plug element 150 is arranged at a distal end 102 of the article 100 to cover and protect the distal front end of the substrate element 110, whereas the filter element 160 is arranged at a proximal end 103 of the article 100. Both, the distal front plug element 150 and the filter element 160 may be made of the same filter material. The filter element 160 preferably serves as a mouthpiece, preferably as part of a mouthpiece together with the second tube element 145. The filter element 160 may have a length of 10 millimeter to 14 millimeter, for example, 12 millimeter, whereas the distal front plug element 150 may have a length of 3 millimeter to 6 millimeter, for example, 5 millimeter. The substrate element 110 comprises an aerosol-forming substrate 130 to be heated as well as a multi-layer susceptor arrangement 120 according to an exemplary embodiment of the present invention for heating the substrate 130. At hand, the susceptor arrangement 120 has the form of a blade or a strip that is fully embedded in the substrate 130 such as to be in direct thermal contact with the substrate 130. The substrate element 110 may have a length of 10 millimeter to 14 millimeter, for example, 12 millimeter. As shown in FIG. 1, the susceptor arrangement 120 extends along the entire length of the substrate element 110, but may alternatively have a length extension shorter than the length of the substrate element 110. Each one of the first and the second tube element 140, 145 is a hollow cellulose acetate tube having a central air passage 141, 146, wherein a cross-section of the central air passage 146 of the second tube element 145 is larger than a cross-section of the central air passage 141 of the first tube element 140. The first and second tube elements 140, 145 may have a length of 6 millimeter to 10 millimeter, for example, 8 millimeters. Each of the aforementioned elements 150, 110, 140, 145, 160 may be substantially cylindrical. In particular, all elements 150, 110, 140, 145, 160 may have the same outer cross-sectional shape and dimensions.

In addition, the elements 150, 110, 140, 145, 160 may be circumscribed by one or more outer wrappers such as to keep the elements together and to maintain the desired cross-sectional shape of the rod-shaped article. In the present embodiment, the distal front plug element 150, the substrate element 110 and the first tube element 140 are circumscribed by a first wrapper 171, whereas the second tube element 145 and the filter element 160 are circumscribed by a second wrapper 172. The second wrapper 172 also circumscribes at least a portion of the first tube element 140 (after being wrapped by the first wrapper 171) to connect the distal front plug element 150, the substrate element 110 and the first tube element 140 being circumscribed by the first wrapper 171 to the second tube element 145 and the filter element 160. Preferably, the first and the second wrappers 171, 172 are made of paper. In addition, the second wrapper 172 may comprise perforations around its circumference (not shown). The wrappers 171, 172 may further comprise adhesive that adheres the overlapped free ends of the wrappers 171, 172 to each other. As illustrated in FIG. 2, the aerosol-generating article 100 is configured for use with an inductively heating aerosol-generating device 10. Together, the device 10 and the article 100 form an aerosol-generating system 1 according to the present invention. The aerosol-generating device 10 comprises a cylindrical receiving cavity 20 defined within a proximal portion 12 of the device 10 for receiving a least a distal portion of the article 100 therein. The device 10 further comprises an inductive heating arrangement including an induction coil 30 for generating a high-frequency alternating magnetic field within the cavity 20. In the present embodiment, the induction coil 30 is a helical coil circumferentially surrounding the cylindrical receiving cavity 20. The coil 30 is arranged such that the susceptor arrangement 120 of the aerosol-generating article 100 is exposed to the alternating magnetic field upon inserting the article 100 into the cavity 20 of the device 10. Thus, when activating the inductive heating arrangement, the susceptor arrangement 120 heats up due to eddy currents and/or hysteresis losses that are induced by the alternating magnetic field, depending on the magnetic and electric properties of the susceptor materials of the susceptor arrangement 120. The susceptor arrangement 120 is heated until reaching an operating temperature sufficient to vaporize the aerosol-forming substrate 130 surrounding the susceptor arrangement 120 within the article 100. In use, aerosol formed by volatile compounds released from the heated substrate 130 is drawn through the first and second tube element 140, 145 and further through the filter element 160 towards the proximal end 103 of the article 100.

Within a distal portion 13, the aerosol-generating device 10 further comprises a DC power supply 40 and a controller 50 (only schematically illustrated in FIG. 2) for powering and controlling the heating process. Apart from the induction coil 30, the inductive heating arrangement preferably is at least partially integral part of the controller 50.

FIG. 3 and FIG. 4 show detailed views (not to scale) of the susceptor arrangement 120 used within the aerosol-generating article shown in FIG. 1. According to the invention, the susceptor arrangement 120 is a multi-layer susceptor arrangement 120 comprising a first layer 121, a second layer 122 and a third layer 123, which are arranged such that the second layer 122 is sandwiched between the first layer 121 and the third layer 123. In the present invention, the multi-layer susceptor arrangement 120 consist of these three layers 121, 122, 123 only. Accordingly, the first and third layer 121, 123 each form an edge layer of the susceptor arrangement 120.

As can be seen from FIG. 3 and FIG. 4, the second layer 122 is intimately coupled to the first layer 121, whereas the third layer 123 is intimately coupled to the second layer 121, opposite to the first layer 121. Manufacturing-wise, the susceptor arrangement 120 may be formed, for example, by first cladding the material of the second layer 122 to the material of the first layer 121. After that, the material of the third layer 123 may be cladded on top of the second layer 122. The first layer 121 primarily is used for heating purposes. For this, the first layer consists of a first susceptor material that is optimized with regard to heat loss and thus heating efficiency. At hand, the first susceptor material is a 400 series stainless steel such as grade 410 stainless steel, or grade 420 stainless steel, or grade 430 stainless steel, or stainless steel of similar grades. Using a stainless steel proves advantageous with regard to the aging characteristics of the first layer 121 being in direct contact with the aerosol-forming substrate 130 in the substrate element 110.

While the first layer 121 is primarily used for heating the substrate 130, the second layer 122 primarily is a functional layer serving as temperature marker. For this, the second layer 122 comprises a ferromagnetic second susceptor material which is chosen such as to have a Curie temperature corresponding to a predefined temperature point for heating the substrate 130. At its Curie temperature, the magnetic permeability of the second susceptor material drops to unity leading to a change of its magnetic properties from ferromagnetic to paramagnetic. The change of the magnetic properties is accompanied by a temporary change of the electrical resistance of the susceptor arrangement 120. Thus, by monitoring a corresponding change of the electrical current absorbed by the inductive heating arrangement of the device 10, it can be detected when the second susceptor material has reached its Curie temperature and, thus, when the predefined temperature point has been reached.

As defined above, the second susceptor material comprises or consists of a Ni-Fe-alloy having a Ni content of equal to or smaller than 65 wt %. At hand, the Ni-Fe-alloy comprises 50 wt % Ni, 9 wt % Cr, the rest being Fe. This alloy is commercially available, for example, under the tradename Phytherm 260 and has a Curie temperature of 260° C. If a lower Curie temperature is desired, the Ni-Fe-alloy may alternatively comprise or consist of 50 wt % Ni, 10 wt % Cr, the rest being Fe. This alloy has a Curie temperature of 230° C. and is also commercially available, for example, under the tradename Phytherm 220. According to yet another alternative, the Ni-Fe-alloy may comprise or consist of 50 wt % Ni, 11 wt % Cr, the rest being Fe. This alloy is also commercially available, for example, under the tradename Phytherm 210 and has a Curie temperature of 210° C. Advantageously, all of the aforementioned alloys (Phytherm alloys) are anti-corrosive materials.

Although Phytherm alloys are already anti-corrosive materials, it is preferred that the second layer 122 is protected not only from one side by the first layer 121, but also from the opposite side. This is accomplished by the third layer 123. In particular, the third layer 123 may reduce material diffusion, for example metal diffusion, from the second susceptor material into the surrounding aerosol-forming substrate 130. Furthermore, the third layer 123 may help to avoid or reduce thermal bending due to differences in thermal dilatation between the various layers 121, 122, 123.

Preferably, the third layer 123 comprises or consists of the same material as the first layer 121. Due to this, the multi-layer susceptor arrangement 120 comprises at least two layers 121, 123 having the same coefficient of thermal expansion which results in reduced deformations of the susceptor arrangement 120 across its temperature range of operation. Hence, in the present embodiment, the third material of the third layer 123 preferably also is a 400 series stainless steel such as grade 410 stainless steel, or grade 420 stainless steel, or grade 430 stainless steel, or stainless steel of similar grades.

Alternatively, the third material of the third layer 123 may be an austenitic stainless steel. As an example, third material of the third layer 123 may be X5CrNi18-10 or X2CrNiMo17-12-2 (according to EN (European Standards) nomenclature). In particular, third material of the third layer 123 may be one of 301 stainless steel, 304 stainless steel, 304L stainless steel, 316 stainless steel or 316L stainless steel (nomenclature according to SAE steel grades [Society of Automotive Engineers]). Advantageously, due to its paramagnetic characteristics and high electrical resistance, austenitic stainless steel only weakly shields the second susceptor material of the second layer 222 from the magnetic field to be applied thereto.

As described further above, it has been found that that the layer thickness of the third layer 123 can be relatively small, namely, equal to or smaller than 50% of a layer thickness of the first layer 121, while still properly protecting the second layer 122. A small third layer thickness proves beneficial not only in terms material savings, but also in that the second layer 122 is less shielded from the alternating magnetic field of the induction source used to inductively heat the susceptor arrangement 120. As a result, when using the second susceptor material as a temperature maker, the effect of the above-described change in the magnetic properties of the second susceptor material on the electrical current through the induction source is more pronounced. Advantageously, this makes it possible to determine more reliably when the second susceptor material has reached its Curie temperature and thus when the predefined temperature point has been reached. In the present embodiment, the first layer 121 has a layer thickness in a range between 42 micrometer and 43 micrometer, whereas the third layer 123 has a layer thickness in a range between 3 micrometer and 4 micrometer. Accordingly, the layer thickness of the third layer 123 is in a range between about 7% to 9% of the layer thickness of the first layer 121.

The layer thickness of the second layer 122 may be between the layer thickness of the first layer 121 and the third layer 123. At hand, the second layer 122 has a layer thickness in a range between 10 micrometer and 16 micrometer or between 13 micrometer and 15 micrometer, preferably about 10 micrometer or about 14 micrometer.

As can be particularly seen in FIG. 3, the multi-layer susceptor arrangement 120 according to the present embodiment is in the form of an elongate strip. The strip-shaped susceptor arrangement 120 has a length L of 10 millimeter to 12 millimeter and a width W of 4 millimeter to 5 millimeter. That is, all three layers 121, 122, 123 have a length L of 10 millimeter to 12 millimeter and a width W of 4 millimeter to 5 millimeter, yet different layer thicknesses. Given the above values for the respective layer thicknesses, the total thickness T of the susceptor arrangement 120 is in a range between 55 micrometer and 63 micrometer, for example about 56 micrometer or about 60 micrometer.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. A multi-layer susceptor arrangement for inductively heating an aerosol-forming substrate, the multi-layer susceptor arrangement comprising:
a first layer comprising a first susceptor material;
a second layer comprising a second susceptor material; and
a third layer comprising a third material,
wherein the second layer is sandwiched between the first layer and the third layer,
wherein the second susceptor material comprises a Ni-Fe-alloy having a Ni content of equal to or smaller than 65 wt %, and
wherein a layer thickness of the third layer is equal to or smaller than 20% of a layer thickness of the first layer.

17. The multi-layer susceptor arrangement according to claim 16, wherein the layer thickness of the third layer is equal to or smaller than 15% of the layer thickness of the first layer.

18. The multi-layer susceptor arrangement according to claim 16, wherein a layer thickness of the first layer is in a range between 1.5 and 5 times the layer thickness of the second layer.

19. The multi-layer susceptor arrangement according to claim 18, wherein a layer thickness of the first layer is about 3 times the layer thickness of the second layer.

20. The multi-layer susceptor arrangement according to claim 16, wherein the first susceptor material comprises a metal.

21. The multi-layer susceptor arrangement according to claim 16, wherein the first susceptor material comprises ferritic iron, or a grade 410 stainless steel, or a grade 420 stainless steel, or a grade 430 stainless steel.

22. The multi-layer susceptor arrangement according to claim 16, wherein the Ni-Fe-alloy of the second susceptor material further comprises 8 wt %-12 wt % Cr.

23. The multi-layer susceptor arrangement according to claim 16, wherein the Ni-Fe-alloy of the second susceptor material further comprises 9 wt %-11 wt % Cr.

24. The multi-layer susceptor arrangement according to claim 16, wherein the Ni-Fe-alloy of the second susceptor material has a Ni content of equal to or smaller than 50 wt %, the rest being Fe.

25. The multi-layer susceptor arrangement according to claim 16, wherein the Ni-Fe-alloy of the second susceptor material comprises one of:
50 wt % Ni, 9 wt % Cr, the rest being Fe,
50 wt % Ni, 10 wt % Cr, the rest being Fe,
50 wt % Ni, 11 wt % Cr, the rest being Fe,
50 wt % Ni, 9 wt % Cr, up to 1 wt % Si, and up to 1 wt % Mn, the rest being Fe,
50 wt % Ni, 10 wt % Cr, up to 1 wt % Si, and up to 1 wt % Mn, the rest being Fe,
50 wt % Ni, 11 wt % Cr, up to 1 wt % Si, and up to 1 wt % Mn, the rest being Fe.

26. The multi-layer susceptor arrangement according to claim 16, wherein the Ni-Fe-alloy of the second susceptor material has a Curie temperature in a range between 180° C. and 420° C.

27. The multi-layer susceptor arrangement according to claim 16, wherein the Ni-Fe-alloy of the second susceptor material has a Curie temperature in a range between 210° C. and 380° C.

28. The multi-layer susceptor arrangement according to claim 16, wherein the third material is an anti-corrosive material.

29. The multi-layer susceptor arrangement according to claim 16,
wherein the third material is identical to the first susceptor material, or
wherein the third material is different from the first susceptor material.

30. The multi-layer susceptor arrangement according to claim 16, wherein a layer thickness of the first layer is in range between 20 micrometers and 60 micrometers.

31. The multi-layer susceptor arrangement according to claim 16, wherein a layer thickness of the second layer is in range between 4 micrometers and 20 micrometers.

32. The multi-layer susceptor arrangement according to claim 16, wherein a layer thickness of the second layer is in range between 8 micrometers and 18 micrometers.

33. The multi-layer susceptor arrangement according to claim 16,
wherein the layer thickness of the third layer is equal to or smaller than 8 micrometer, and/or
wherein the layer thickness of the third layer is at least 0.75 micrometer.

34. The multi-layer susceptor arrangement according to claim 16, wherein the layer thickness of the third layer is in range between 0.75 micrometer and 8 micrometers.

35. An inductively heatable aerosol-generating article comprising at least one aerosol-forming substrate and a multi-layer susceptor arrangement according to claim 16.
